(19) United States
(12) Patent Application Publication
(10) Pub. No.: US 2022/0113833 A1
(43) Pub. Date: Apr. 14, 2022

(54) PROCESSING METHOD AND SYSTEM FOR TOUCH SIGNALS, AND ALL-IN-ONE TOUCH MACHINE

(71) Applicant: SHENZHEN KTC COMMERCIAL DISPLAY TECHNOLOGY CO., LTD., Shenzhen (CN)

(72) Inventors: Shichao Xu, Shenzhen (CN); Xudong Li, Shenzhen (CN); Kehua Liao, Shenzhen (CN)

(21) Appl. No.: 17/489,743

(22) Filed: Sep. 29, 2021

Related U.S. Application Data
(63) Continuation of application No. PCT/CN2020/120729, filed on Oct. 14, 2020.

(51) Int. Cl. G06F 3/042

(52) U.S. Cl. CPC G06F 3/0421; G06F 2203/04109

(57) ABSTRACT

Disclosed are a processing method and system for touch signals, and an all-in-one touch machine. The method includes: obtaining current infrared signal data on a surface of an infrared touch bezel; obtaining touch-obstructed areas according to the current infrared signal data; determining whether the number of the touch-obstructed areas is greater than a predetermined value, uploading the current infrared signal data to the control mainboard if the number is greater than the predetermined value, or performing simple touch-control calculations on the current infrared signal data through the infrared touch bezel if the number is less than or equal to the predetermined value and obtaining coordinate information of a touch point; performing complex touch-control calculations by the control mainboard according to the current infrared signal data received, and obtaining the coordinate information of the touch point and returning the coordinate information to the infrared touch bezel.

### CROSS REFERENCE TO RELATED APPLICATIONS

This application is a continuation application of PCT/CN2020/120729, filed on Oct. 14, 2020, the content of the application is hereby incorporated by reference in its entirety.

### TECHNICAL FIELD

This disclosure relates to the field of touch data processing technique, and in particular to a processing method and a system for touch signals, and an all-in-one touch machine.

### BACKGROUND

The infrared touch technologies of the infrared touch bezel generally uses a main control chip MCU to control the digital logic chip on the circuit by designing the circuit, and collects infrared signal controlled by the infrared emitting lamps and receiving lamps on the circuit of the touch bezel, and then analyzes and processes the collected signals using software algorithm, so as to calculate the touch points and related coordinate information, and report to the system according to a certain protocol to realize the multiple touch points effect.

The control touch algorithm program of the infrared touch bezel is usually executed in the main control chip MCU for processing calculation, however, the main control chip is restricted by technology and intrinsic characteristics, such as small memory storage, low calculation frequency, etc., which results in poor calculation processing capabilities, inaccuracy in detection and calculation of touch points, and slow response in the touch frame bezel. Therefore, the main control chip MCU on the existing infrared touch screens can no longer meet the needs of data processing on a large number of signals acquired by the touch screen in terms of high-standard touch recognition, high-precision analysis and processing.

In order to solve the above-mentioned problems, the existing infrared touch bezel is connected to the system board. The infrared signal data is acquired through the infrared touch bezel and transmitted to the system board. The system board performs touch-control calculation on the infrared signal data and returns the obtained touch points and related coordinate information. This solves the inaccurate detection of the touch points and slow touch response caused by insufficient processing and calculation capabilities of the infrared touch bezel, and improves the touch-control experience. However, simple calculations which could be processed by the infrared touch bezel are also uploaded to the system board, thus this increases the time taken to send the infrared signal data to the system board from the infrared touch bezel, and return the calculation results back to the infrared touch bezel after performing touch-control calculation in the system board. Therefore, the processing of infrared signal data in the prior art needs to be optimized, and the touch response and experience still need to be improved

### SUMMARY OF THE APPLICATION

An objective of the present disclosure is to provide a processing method and a system for touch signals, and an all-in-one touch machine, in order to optimize the processing of infrared signal data and enhances the touch response and experience in the prior art.

In a first aspect, an embodiment of the present disclosure provides a processing method for touch signals, which includes:

obtaining current infrared signal data on a surface of an infrared touch bezel by the infrared touch bezel;

comparing the current infrared signal data with a pre-stored signal data baseline library and obtaining current touch-obstructed areas by the infrared touch bezel;

determining whether the number of the touch-obstructed areas is greater than a predetermined value, uploading the current infrared signal data to a control mainboard if the number is greater than the predetermined value; or performing touch-control calculations on the current infrared signal data by the infrared touch bezel if the number is less than or equal to the predetermined value, obtaining coordinate information of a touch point, and reporting the coordinate information of the touch point to a system to achieve a touch-control function;

performing the touch-control calculations by the control mainboard according to the current infrared signal data received, obtaining the coordinate information of the touch point and returning the coordinate information back to the infrared touch bezel, and reporting the coordinate information of the touch point to the system by the infrared touch bezel to achieve the touch-control function.

In a second aspect, an embodiment of the present disclosure provides a processing system for touch signals, which includes: an infrared touch bezel and a control mainboard. The infrared touch bezel is in communication connection with the control mainboard. The infrared touch bezel includes an acquisition unit, a comparison unit, and a first touch processing unit. The control mainboard includes a second touch processing unit.

Further, the acquisition unit is used for acquiring current infrared signal data on a surface of the infrared touch bezel;

Further, the comparison unit is used for comparing the current infrared signal data with a pre-stored signal data baseline library and obtaining current touch-obstructed areas in the infrared touch bezel;

Further, the first touch processing unit is used for determining whether the number of the touch-obstructed areas is greater than a predetermined value, uploading the current infrared signal data to the control mainboard if the number is greater than the predetermined value, or performing touch-control calculations on the current infrared signal data by the infrared touch bezel if the number is less than or equal to the predetermined value, and obtaining coordinate information of a touch point, and reporting the coordinate information of the touch point to a system to achieve a touch-control function;

The second touch processing unit is used for performing the touch-control calculations by the control mainboard according to the current infrared signal data received, and obtaining the coordinate information of the touch point and returning the coordinate information to the infrared touch bezel. The coordinate information of the touch point is reported to the system by the infrared touch bezel to achieve the touch-control function.

In a third aspect, an embodiment of the present disclosure further provides an all-in-one touch machine, which includes an infrared touch bezel, a control mainboard, a PC module, and a display device. The infrared touch bezel is connected to the control mainboard via USB, and the control mainboard is used for turning on the display device. The infrared touch bezel is connected to a signal switch via the USB, and the signal switch is connected to the PC module or an external device through a first transmission port, the signal switch is connected to the PC module or the external device through a second transmission port. The all-in-one touch machine is used to implement the above-mentioned processing method for touch signals.

In a fourth aspect, an embodiment of the present disclosure further provides an all-in-one touch machine, which includes an infrared touch bezel and a control mainboard. The infrared touch bezel includes a first memory, a first processor, and a first computer program stored on the first memory and can run on the first processor. The control mainboard includes a second memory, a second processor, and a second computer program stored on the second memory and can run on the second processor. The first processor executes the first computer program and the second processor executes the second computer program to implement the above-mentioned processing method for touch signals together.

The present disclosure provides a processing method and system for touch signals, and an all-in-one touch machine. The method includes: obtaining current infrared signal data on a surface of an infrared touch bezel; obtaining a touch-obstructed area according to the current infrared signal data; determining whether the number of the touch-obstructed areas is greater than a predetermined value; uploading the current infrared signal data to the control mainboard if the number is greater than the predetermined value, and performing simple touch-control calculations on the current infrared signal data through the infrared touch bezel if the number is less than or equal to the predetermined value and obtaining coordinate information of a touch point; performing complex touch-control calculations by the control mainboard according to the current infrared signal data received, obtaining the coordinate information of the touch points and feeding it back to the infrared touch bezel, and reporting the coordinate information of the touch point to the system by the infrared touch bezel to achieve the touch-control function. In the embodiment of the disclosure, complexities of the touch-control calculations of the current infrared signal data is refined by the infrared touch bezel, in order to optimize the touch-control calculations and enhances the touch response and experience.

### BRIEF DESCRIPTION OF THE DRAWINGS

In order to more clearly illustrate the technical proposals of the present disclosure, the drawings used in the embodiments will be briefly described below. Apparently, the drawings in the following description are merely some embodiments of the present disclosure, those skilled in the art can obtain other drawings based on these drawings without creative work.

FIG. 1 is a flowchart of a processing method for touch signals provided by an embodiment of the present disclosure;

FIG. 2 is a flowchart showing a sub-process of the processing method for touch signals provided by an embodiment of the present disclosure;

FIG. 3 is a flowchart showing another sub-process of the processing method for touch signals provided by an embodiment of the present disclosure;

FIG. 4 is a flowchart showing yet another sub-process of the processing method for touch signals provided by an embodiment of the present disclosure;

FIG. 5 is a flowchart showing still another sub-process of the processing method for touch signals provided by an embodiment of the present disclosure;

FIG. 6 is a schematic diagram of an all-in-one touch machine provided by an embodiment of the present disclosure; and

FIG. 7 is a block diagram of a processing system for touch signals provided by an embodiment of the present disclosure.

### DESCRIPTION OF THE EMBODIMENTS

The technical proposals in the embodiments of the present disclosure will be clearly and completely described in conjunction with the accompanying drawings in the embodiments of the present disclosure. It is apparent that the described embodiments are merely part of the embodiments of the present disclosure rather than all embodiments. Based on the embodiments of the present disclosure, all other embodiments obtained by those skilled in the art without creative work fall within the scope of protection of the present disclosure.

It should be understood that, when used in this specification and the appended claims, the terms “include” and “comprise” indicate the presence of the described features, integers, steps, operations, elements and/or components, but do not preclude the presence or addition of a plurality of other features, integers, steps, operations, elements, components, and/or collections thereof.

It should also be understood that the terms used in this description of the present disclosure is merely illustrative of the specific embodiments, but not intended to limit the scope of the present disclosure. As used in the specification and the appended claims of the present disclosure, unless the context clearly indicates otherwise, the singular forms “a”, “an” and “the” are intended to include plural forms.

It should be further understood that the term “and/or” used in the specification and appended claims of the present disclosure refers to any combination of one or more of the items listed in the associated and all possible combinations, and includes these combination.

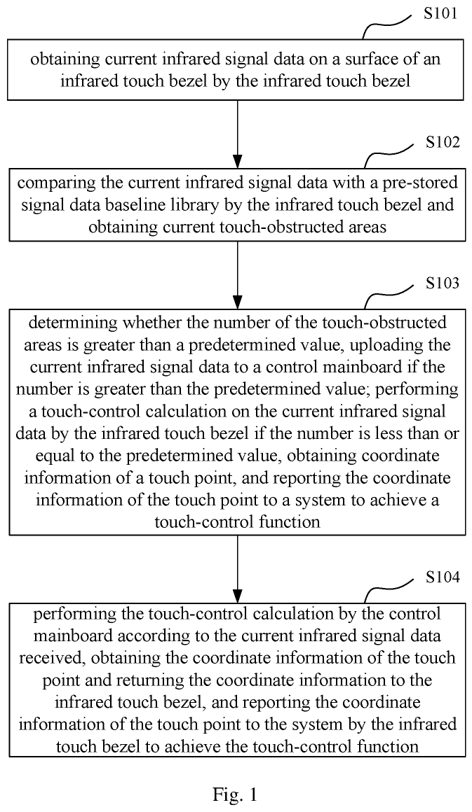

Referring to FIG. 1, FIG. 1 is a flowchart of a processing method for touch signals provided by an embodiment of the present disclosure.

As shown in FIG. 1, a processing method for touch signals is applied to a processing system for touch signals. The processing system for touch signals includes an infrared touch bezel and a control mainboard, and the infrared touch bezel is in communication connection with the control mainboard. The processing method includes steps S101-S104.

S101: obtaining current infrared signal data on a surface of an infrared touch bezel by the infrared touch bezel;

In this embodiment, a plurality of infrared emitting lamps are arranged side by side on one side of the infrared touch bezel along a transverse direction and one side thereof along a longitudinal direction; and a plurality of infrared receiving lamps corresponding to the infrared emitting lamps are arranged side by side on the other side of the infrared touch bezel along the transverse direction and the other side thereof along the longitudinal direction. The infrared touch bezel controls the infrared emitting lamps and the infrared receiving lamps on and off. The infrared receiving lamps are turned on when the infrared emitting lamps are on, so that the infrared receiving lamps receive the infrared signal emitted by the infrared emitting lamps. The current infrared signal data on the surface of the infrared touch bezel is obtained according to the infrared signal received.

In an embodiment, step S101 includes:

collecting intensities of the infrared signals received by the infrared receiving lamps on the circuit of the infrared touch bezel, and sorting the intensities of the infrared signals of the each of the infrared receiving lamps to generate the current infrared signal data.

In this embodiment, infrared signals with variable intensities are generated in the circuit of the infrared touch bezel after the infrared receiving lamps receive the infrared signals emitted by the infrared emitting lamps, and the intensities of the infrared signals are operated and amplified by the circuit of the infrared touch bezel, and then AD conversion is carried out and collected to calculate the values of the intensities of the infrared signals. The intensity of the infrared signal of each infrared receiving lamp is sorted, forming the current infrared signal data.

S102: comparing the current infrared signal data with a pre-stored signal data baseline library by the infrared touch bezel and obtaining current touch-obstructed areas.

In this embodiment, the signal data baseline library is used to determine whether there is a touch-obstructed area, and the signal data baseline library is a signal status library of each infrared receiving lamp established by the infrared touch bezel when there is no touch or obstruction. By comparing the current infrared signal data with the signal data baseline library, the infrared signal that is changed is obtained, and the area corresponding to the changed infrared signal is determined to be the current touch-obstructed area.

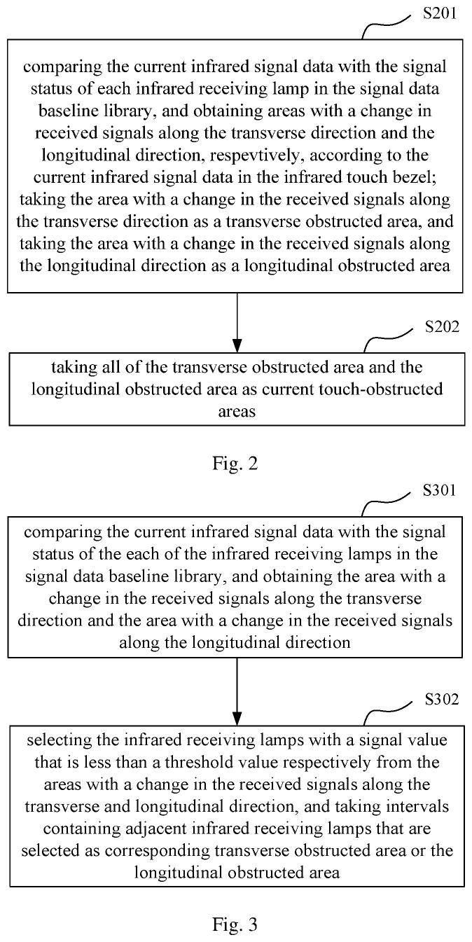

In an embodiment as shown in FIG. 2, step S102 includes:

S201: comparing the current infrared signal data with the signal status of each infrared receiving lamp in the signal data baseline library, and obtaining an area with a change in received signals along the transverse direction and an area with a change in the received signals along the longitudinal direction according to the current infrared signal data in the infrared touch bezel. Taking the area with a change in the received signals along the transverse direction as a transverse obstructed area, and taking the area with a change in the received signals along the longitudinal direction as a longitudinal obstructed area.

S202: taking all of the transverse obstructed area and the longitudinal obstructed area as the current touch-obstructed areas.

In this embodiment, the current infrared signal data is compared with the signal status of each of the infrared receiving lamps in the signal data baseline library, and an area with a change in the received signals along the transverse direction and an area with a change in the received signals along the longitudinal direction are determined, so that a transverse changing area and a longitudinal changing area are determined. In the transverse changing area, an interval with a plurality of adjacent infrared signal receiving lamps is regarded as the transverse obstructed area. In the longitudinal changing area, an interval of a plurality of adjacent infrared signal receiving lamps is regarded as the longitudinal obstructed area. Specifically, for example, 50 infrared receiving lamps in an order of 1-50 are arranged in the transverse direction, and 50 infrared receiving lamps in an order of 51-100 are arranged in the longitudinal direction; if the received signals of the infrared receiving lamps 20-23 change when the surface of the infrared touch bezel is touched, then the interval containing the infrared receiving lamps 20-23 is the transverse obstructed area. At the same time, the received signals change in the longitudinal direction corresponding to the change in the transverse direction. For example, if the received signals of the infrared receiving lamps 60-63 change, an interval containing the infrared receiving lamps 60-63 is the corresponding longitudinal obstructed area.

All of the transverse obstructed area and the longitudinal obstructed area are regarded as the current touch-obstructed areas, which are used for subsequent calculation of the coordinates of the touch points.

In an embodiment as shown in FIG. 3, step S201 includes:

S301: comparing the current infrared signal data with the signal status of the each of the infrared receiving lamps in the signal data baseline library, and obtaining the area with a change in the received signals along the transverse direction and the area with a change in the received signals along the longitudinal direction.

S302: selecting the infrared receiving lamps with a signal value that is less than a threshold value respectively from the areas with a change in the received signals along the transverse and longitudinal direction, and taking intervals containing adjacent infrared receiving lamps that are selected as corresponding transverse obstructed area or the longitudinal obstructed area.

In this embodiment, the light paths of the infrared receiving lamps are obstructed when touching the infrared touch bezel, which causes the infrared signal received by the infrared receiving lamps to become weak, namely the signal value becomes smaller. Since the smaller the signal value, the more likely the infrared receiving lamp corresponding to the signal value is to be obstructed, thus a threshold is set for the signal value, and the area of the infrared receiving lamps with signal values less than the threshold is determined as the obstructed area, and the area of the infrared receiving lamps with signal values larger than or equal to the threshold is determined as an unobstructed area. Specifically, taking the above example, the signal value of 100 infrared receiving lamps in the non-touch state is 10, and the signal threshold may be set to 6 or other values. In the case where the threshold is 6, if the infrared touch bezel is touched, the signal value of the infrared receiving lamps 20-23 in the transverse direction is smaller than 6, thus the interval containing the infrared receiving lamps 20-23 is a transverse obstructed area, correspondingly, if the signal value of the infrared receiving lamps 60-63 in the longitudinal direction is smaller than 6, the infrared receiving lamps 60-63 then form a longitudinal obstructed area.

S103: determining whether the number of the touch-obstructed areas is greater than a predetermined value, uploading the current infrared signal data to a control mainboard if the number is greater than the predetermined value; performing a touch-control calculation on the current infrared signal data by the infrared touch bezel if the number is less than or equal to the predetermined value, obtaining coordinate information of a touch point, and reporting the coordinate information of the touch point to a system to achieve a touch-control function;

In this embodiment, the touch-control calculation may be carried out by both of the infrared touch bezel and the control mainboard, however, the infrared touch bezel has limited internal computing and processing capabilities, hence the touch-control calculation can only run on a small number of the touch-obstructed areas. When the number of the areas is large and the touch-control calculation is more complicated, the infrared signal data needs to be uploaded to the control mainboard, the touch-control calculation is carried out using a powerful computing power and memory computing function of the control mainboard, and the coordinate information of the touch point is returned, thereby improving the touch-control experience.

A predetermined value is set, and the number of areas of the current touch-obstructed areas is compared with the predetermined value to obtain a comparison result. The current infrared signal data is uploaded to the control mainboard to perform the touch-control calculation if the number of the areas is greater than the predetermined value according to the comparison result, and the coordinate information of the touch point is returned; the touch-control calculation on the current infrared signal data is carried out by the infrared touch bezel if the number of the areas is less than or equal to the predetermined value, and the coordinate information of the touch point is obtained; and the coordinate information of the touch point is reported to the system by the infrared touch bezel to achieve the touch-control function.

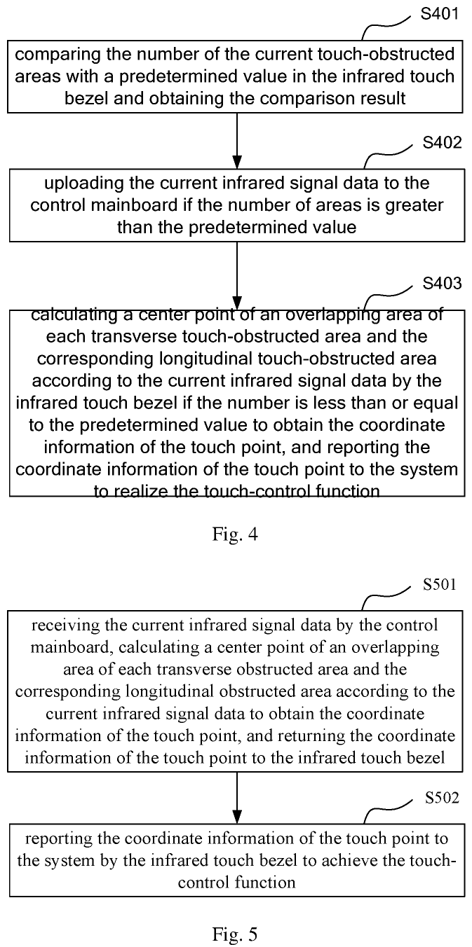

In an embodiment as shown in FIG. 4, the step S103 includes:

S401: comparing the number of the current touch-obstructed areas with a predetermined value in the infrared touch bezel and obtaining the comparison result;

S402: uploading the current infrared signal data to the control mainboard if the number of areas is greater than the predetermined value;

S403: calculating a center point of an overlapping area of each transverse touch-obstructed area and the corresponding longitudinal touch-obstructed area according to the current infrared signal data by the infrared touch bezel if the number is less than or equal to the predetermined value to obtain the coordinate information of the touch point, and reporting the coordinate information of the touch point to the system to realize the touch-control function.

In this embodiment, the predetermined value may be 4 or other values set according to the computing and processing capabilities of the infrared touch bezel. In the case that the predetermined value is 4, if the number of the current touch-obstructed areas is greater than 4, the touch-control calculation of the current touch-obstructed areas is determined to be a complex calculation, and the current infrared signal data is uploaded to the control mainboard to perform the complex touch-control calculation by the control mainboard; If the number of the current touch-obstructed areas is less than or equal to 4, the touch-control calculation of the current touch-obstructed areas is a simple calculation, and the touch-control calculation is performed by the infrared touch bezel.

The specific process of performing the touch-control calculation by the infrared touch bezel includes: defining an overlapping area of each pair of the transverse obstructed area and the corresponding longitudinal obstructed area according to the current infrared signal data, determining a center point of the overlapping area as a touch point using geometric operations, and obtaining coordinate information of the center point. That is, one touch point corresponds to one transverse obstructed area and one longitudinal obstructed area on the infrared touch bezel, respectively. Four touch-obstructed areas represent two touch points, thus the complex calculation is not required if the number of the touch points is less than or equal to 2, and the computing and processing capabilities of the infrared touch bezel are adequate. After the coordinate information of the touch points is obtained, the coordinate information is reported to the system by the infrared touch bezel, and the system operates according to the coordinate information of the touch points to realize the touch-control function.

S104: performing the touch-control calculation by the control mainboard according to the current infrared signal data received, obtaining the coordinate information of the touch point and returning the coordinate information to the infrared touch bezel, and reporting the coordinate information of the touch point to the system by the infrared touch bezel to achieve the touch-control function.

In this embodiment, the touch-control calculation is carried out rapidly using a powerful computing power and memory computing function of the control mainboard after the current infrared signal data is received, and the coordinate information of the touch points is returned to the infrared touch bezel, thereby improving the response speed and the touch experience of the infrared touch bezel.

In an embodiment as shown in FIG. 5, step S104 includes:

S501: receiving the current infrared signal data by the control mainboard, calculating a center point of an overlapping area of each transverse obstructed area and the corresponding longitudinal obstructed area according to the current infrared signal data to obtain the coordinate information of the touch point, and returning the coordinate information of the touch point to the infrared touch bezel;

S502: reporting the coordinate information of the touch point to the system by the infrared touch bezel to achieve the touch-control function.

In this embodiment, after the current infrared signal data is received by the control mainboard, the transverse obstructed area and the corresponding longitudinal obstructed area are obtained according to the current infrared signal data, the overlapping area of the transverse and the longitudinal obstructed areas is defined, the center point of the overlapping area as a touch point is obtained using geometric operations, and the coordinate information of the touch point is obtained. The coordinate information of all of the touch points is sent back to the infrared touch bezel, and the coordinate information is reported to the system by the infrared touch bezel, and the system operates according to the coordinate information of the touch points to realize the touch-control function.

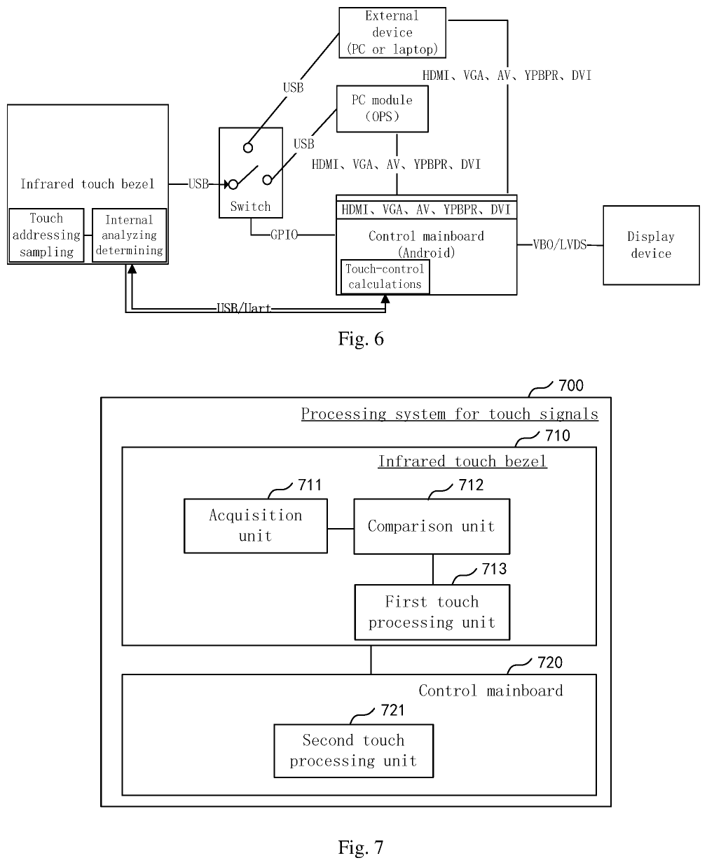

Referring to FIG. 6, in an embodiment, step S502 includes:

transmitting the coordinate information of the touch point to a signal switch through USB, and further to a PC module or an external device through the signal switch, in order to realize the touch-control function.

In this embodiment, the coordinate information of the touch point is transmitted from the infrared touch bezel to the signal switch through the USB, and may be further transmitted to the PC module from the signal switch thorough a first transmission port. The PC module implements the corresponding touch function on its own display apparatus according to the received coordinate information of the touch point. The coordinate information of the touch point may be transmitted to the external device from the signal switch thorough a second transmission port, and the external device implements the corresponding touch function on its own display according to the received coordinate information of the touch point.

An embodiment of the present disclosure provides a processing system 700 for touch signals, the processing system 700 is used for performing any one of the embodiments of the above-mentioned processing method for touch signals. Specifically, referring to FIG. 7, FIG. 7 is a block diagram of the processing system 700 for touch signals provided by an embodiment of the present disclosure. The processing system 700 for touch signals includes an infrared touch bezel 710 and a control mainboard 720.

As shown in FIG. 7, the infrared touch bezel 710 includes an acquisition unit 711, a comparison unit 712, and a first touch processing unit 713. The control mainboard 720 includes a second touch processing unit 721.

The acquisition unit 711 is used for acquiring current infrared signal data on a surface of the infrared touch bezel.

The comparison unit 712 is used for comparing the current infrared signal data with a pre-stored signal data baseline library and obtaining current touch-obstructed area in the infrared touch bezel.

The first touch processing unit 713 is used for determining whether the number of the touch-obstructed areas is greater than a predetermined value, uploading the current infrared signal data to the control mainboard if the number is greater than the predetermined value, or performing touch-control calculations on the current infrared signal data by the infrared touch bezel if the number is less than or equal to the predetermined value, and obtaining coordinate information of a touch point, and reporting the coordinate information of the touch point to a system to achieve a touch-control function.

The second touch processing unit is used for performing the touch-control calculations by the control mainboard according to the current infrared signal data received, and obtaining the coordinate information of the touch point and feeding the coordinate information back to the infrared touch bezel. The coordinate information of the touch point is reported to the system by the infrared touch bezel to achieve the touch-control function.

In the above-mentioned processing system, the complexities of the touch-control calculations of the current infrared signal data is refined by the infrared touch bezel, in order to optimize the touch-control calculations and enhances the touch response and experience.

As shown in FIG. 7, an embodiment of the present disclosure further provides an all-in-one touch machine, which includes an infrared touch bezel, a control mainboard. The infrared touch bezel is in communication connection with the control mainboard. The all-in-one touch machine further includes a PC module and a display device, and the all-in-one touch machine may be connected with other external devices. The infrared touch bezel is provided with a touch addressing sampling module and an internal analyzing and determining module. The touch addressing sampling module is used for collecting infrared signals from the infrared receiving lamps, and the internal analyzing and determining module is used for determining the complexity of the touch-control calculation of the current infrared signal data. The infrared touch bezel is connected to the control mainboard via USB, and the control mainboard is used for turning on the display device. The infrared touch bezel is connected to a signal switch through the USB. The signal switch is connected to the PC module through a first transmission port, and to the external device through a second transmission port. The all-in-one touch machine is used for implementing the above-mentioned processing method for touch signals.

An embodiment of the present disclosure further provides an all-in-one touch machine, which includes an infrared touch bezel and a control mainboard. The infrared touch bezel includes a first memory, a first processor, and a first computer program stored on the first memory and can run on the first processor. The control mainboard includes a second memory, a second processor, and a second computer program stored on the second memory and can run on the second processor. The first processor executes the first computer program and the second processor executes the second computer program to implement the above-mentioned processing method for touch signals together.

Those skilled in the art can clearly understand that, for the convenience and brevity of description, the specific working process of the system and the all-in-one touch machine described above can refer to the corresponding process in the foregoing method embodiment, and will not be repeated here. Those skilled in the art can appreciate that the units and algorithm steps described in the exemplary embodiments can be implemented by electronic hardware, computer software, or a combination thereof. In order to clearly illustrate the interchangeability between the hardware and software, the exemplary components and steps are generally described in terms of their functions in the above description. Whether these functions are executed by hardware or software depends on the specific application and design constraints of the technical proposal. Professionals and technicians may use different methods for each specific application to implement the described functions, but such implementation should not be considered beyond the scope of the present disclosure.

It should be understood that, in the embodiments provided by the present disclosure, the disclosed device, system, and method may be implemented in other ways. For example, the system embodiments described above are merely illustrative, e.g. the unit division is merely logical function division. There may be other division in actual implementation, or the units with the same function may be combined into one. For instance, a plurality of units or components can be combined or integrated into another system, or some features can be omitted or not implemented. In addition, the displayed or discussed mutual coupling or direct coupling or communication connection may be indirect coupling or communication connection through some interfaces, devices or units, and may also be electrical, mechanical or other forms of connection.

The units described as separate components may or may not be physically separated, and the components displayed as units may or may not be physical units. That is, they may be located at one position, or they may be distributed on multiple network units. Some or all of the units may be selected according to actual needs to achieve the objectives of the embodiments of the present disclosure.

Additionally, the functional units in the various embodiments of the present disclosure may be integrated into one processing unit, or each unit may exist as a physically separated unit, or two or more units may be integrated into one. The above-mentioned integrated unit can be implemented in the form of hardware or software functional unit.

The integrated unit may be stored in a computer-readable storage medium if it is implemented in the form of a software functional unit and sold or used as an independent product. Based on this understanding, the substantial technical proposal of the present disclosure, or the part that contributes to the existing technology, or all or part of the technical proposal can be implemented in the form of a software, and the computer software is stored in a computer-readable storage medium, and includes several instructions for a computer device (which may be a personal computer, a server, or a network device, etc.) to execute all or part of the steps of the method described in the various embodiments of the present disclosure. The aforementioned computer-readable storage medium includes: a USB disk, a mobile hard disk, read-only memory (ROM), magnetic disk or optical disk and other media that can store program codes.

The above are merely the detailed embodiments of the present disclosure, but the scope of protection of the present disclosure is not limited thereto. Any one skilled in the art can easily think of various equivalent modifications or substitutions within the technical scope disclosed in the present disclosure. These modifications or substitutions shall fall within the scope of protection of the present disclosure. Therefore, the scope of protection of the present disclosure is defined by the appended claims.

What is claimed is:

1. A processing method for touch signals, the method being applied to a processing system for touch signals which comprises an infrared touch bezel and a control mainboard in communication connection with the infrared touch bezel, the method comprising:
obtaining current infrared signal data on a surface of the infrared touch bezel by the infrared touch bezel;
comparing the current infrared signal data with a pre-stored signal data baseline library and obtaining current touch-obstructed areas by the infrared touch bezel;
determining whether the number of the touch-obstructed areas is greater than a predetermined value, uploading the current infrared signal data to the control mainboard if the number is greater than the predetermined value; or performing touch-control calculations on the current infrared signal data by the infrared touch bezel if the number is less than or equal to the predetermined value, obtaining coordinate information of a touch point, and reporting the coordinate information of the touch point to a system to achieve a touch-control function; and
performing the touch-control calculations by the control mainboard according to the current infrared signal data received, obtaining the coordinate information of the touch point and returning the coordinate information to the infrared touch bezel, and reporting the coordinate information of the touch point to the system by the infrared touch bezel to achieve the touch-control function.

2. The processing method for touch signals of claim 1, wherein obtaining current infrared signal data on a surface of the infrared touch bezel comprises:
collecting intensities of the infrared signals received by infrared receiving lamps on a circuit of the infrared touch bezel, and sorting the intensities of the infrared signals of each of the infrared receiving lamps to generate the current infrared signal data.

3. The processing method for touch signals of claim 1, wherein comparing the current infrared signal data with a pre-stored signal data baseline library and obtaining current touch-obstructed areas by the infrared touch bezel comprises:
comparing the current infrared signal data with a signal status of the each of the infrared receiving lamps in the signal data baseline library, the signal status in the signal data baseline library being in a state of no-touch, and obtaining an area with a change in received signals along a transverse direction and an area with a change in the received signals along a longitudinal direction according to the current infrared signal data in the infrared touch bezel, taking the area with a change in the received signals along the transverse direction as a transverse obstructed area, and taking the area with a change in the received signals along the longitudinal direction as a longitudinal obstructed area; and
taking all of the transverse obstructed area and the longitudinal obstructed area as the current touch-obstructed areas.

4. The processing method for touch signals of claim 3, wherein determining whether the number of the touch-obstructed areas is greater than a predetermined value, uploading the current infrared signal data to the control mainboard if the number is greater than the predetermined value, or performing touch-control calculations on the current infrared signal data by the infrared touch bezel if the number is less than or equal to the predetermined value, obtaining coordinate information of a touch point, and reporting the coordinate information of the touch point to a system to achieve a touch-control function comprises:
comparing the number of the current touch-obstructed areas with the predetermined value in the infrared touch bezel and obtaining the comparison result;
uploading the current infrared signal data to the control mainboard if the number of the current touch-obstructed areas is greater than the predetermined value; and
calculating a center point of an overlapping area of each transverse obstructed area and the corresponding longitudinal obstructed area according to the current infrared signal data by the infrared touch bezel if the number is less than or equal to the predetermined value to obtain the coordinate information of the touch point, and reporting the coordinate information of the touch point to the system to realize the touch-control function.

5. The processing method for touch signals of claim 3, wherein performing the touch-control calculations by the control mainboard according to the current infrared signal data received, obtaining the coordinate information of the touch point and returning the coordinate information to the infrared touch bezel, and reporting the coordinate information of the touch point to the system by the infrared touch bezel to achieve the touch-control function comprises:
receiving the current infrared signal data by the control mainboard, calculating a center point of an overlapping area of each transverse obstructed area and a corresponding longitudinal obstructed area according to the current infrared signal data to obtain coordinate information of the touch point, and returning the coordinate information of the touch point to the infrared touch bezel; and
reporting the coordinate information of the touch point to the system by the infrared touch bezel to achieve the touch-control function.

6. The processing method for touch signals of claim 3, wherein comparing the current infrared signal data with a signal status of the each of the infrared receiving lamps in the signal data baseline library, the signal status in the signal data baseline library being in a state of no-touch, and obtaining an area with a change in received signals along a transverse direction and an area with a change in the received signals along a longitudinal direction according to the current infrared signal data in the infrared touch bezel, taking the area with a change in the received signals along the transverse direction as a transverse obstructed area, and taking the area with a change in the received signals along the longitudinal direction as a longitudinal obstructed area comprises:
comparing the current infrared signal data with the signal status of the each of the infrared receiving lamps in the signal data baseline library, the signal status in the signal data baseline library being in the state of no-touch, and obtaining the area with a change in received signals along the transverse direction and the area with a change in the received signals along the longitudinal direction according to the current infrared signal data in the infrared touch bezel; and
selecting the infrared receiving lamps with a signal value that is less than a threshold value respectively from areas with a change in the received signals along the transverse and the longitudinal directions, and taking intervals containing the infrared receiving lamps selected that are adjacent as the transverse obstructed area or the longitudinal obstructed area.

7. The processing method for touch signals of claim 1, wherein reporting the coordinate information of the touch point to a system to achieve a touch-control function comprises:
transmitting the coordinate information of the touch point to a signal switch through USB, and further to a PC module or an external device through the signal switch, in order to realize the touch-control function.

8. A processing system for touch signals, comprising an infrared touch bezel and a control mainboard in communication connection with the infrared touch bezel, the infrared touch bezel including an acquisition unit, a comparison unit, and a first touch processing unit, and the control mainboard including a second touch processing unit, wherein:
the acquisition unit is used for acquiring current infrared signal data on a surface of the infrared touch bezel;
the comparison unit is used for comparing the current infrared signal data with a pre-stored signal data baseline library and obtaining current touch-obstructed areas in the infrared touch bezel;
the first touch processing unit is used for determining whether the number of the touch-obstructed areas is greater than a predetermined value, uploading the current infrared signal data to the control mainboard if the number is greater than the predetermined value; or performing touch-control calculations on the current infrared signal data by the infrared touch bezel if the number is less than or equal to the predetermined value, and obtaining coordinate information of a touch point, and reporting the coordinate information of the touch point to a system to achieve a touch-control function; and
the second touch processing unit is used for performing the touch-control calculations by the control mainboard according to the current infrared signal data received, and obtaining the coordinate information of the touch point and returning the coordinate information to the infrared touch bezel, the coordinate information of the touch point is reported to the system by the infrared touch bezel to achieve the touch-control function.

9. An all-in-one touch machine, comprising an infrared touch bezel and a control mainboard in communication connection with the infrared touch bezel, the all-in-one touch machine is used for implementing the processing method for touch signals of claim 1.

10. The all-in-one touch machine of claim 9, wherein comparing the current infrared signal data with a pre-stored signal data baseline library and obtaining current touch-obstructed areas by the infrared touch bezel comprises:
comparing the current infrared signal data with a signal status of the each of the infrared receiving lamps in the signal data baseline library, the signal status in the signal data baseline library being in a state of no-touch, and obtaining an area with a change in received signals along a transverse direction and an area with a change in the received signals along a longitudinal direction according to the current infrared signal data in the infrared touch bezel, taking the area with a change in the received signals along the transverse direction as a transverse obstructed area, and taking the area with a change in the received signals along the longitudinal direction as a longitudinal obstructed area; and
taking all of the transverse obstructed area and the longitudinal obstructed area as the current touch-obstructed areas.

11. The all-in-one touch machine of claim 10, wherein determining whether the number of the touch-obstructed areas is greater than a predetermined value, uploading the current infrared signal data to the control mainboard if the number is greater than the predetermined value, or performing touch-control calculations on the current infrared signal data by the infrared touch bezel if the number is less than or equal to the predetermined value, obtaining coordinate information of a touch point, and reporting the coordinate information of the touch point to a system to achieve a touch-control function comprises:
comparing the number of the current touch-obstructed areas with the predetermined value in the infrared touch bezel and obtaining the comparison result;
uploading the current infrared signal data to the control mainboard if the number of the current touch-obstructed areas is greater than the predetermined value; and
calculating a center point of an overlapping area of each transverse obstructed area and the corresponding longitudinal obstructed area according to the current infrared signal data by the infrared touch bezel if the number is less than or equal to the predetermined value to obtain the coordinate information of the touch point, and reporting the coordinate information of the touch point to the system to realize the touch-control function.

12. The all-in-one touch machine of claim 10, wherein performing the touch-control calculations by the control mainboard according to the current infrared signal data received, obtaining the coordinate information of the touch point and returning the coordinate information to the infrared touch bezel, and reporting the coordinate information of the touch point to the system by the infrared touch bezel to achieve the touch-control function comprises:
receiving the current infrared signal data by the control mainboard, calculating a center point of an overlapping area of each transverse obstructed area and a corresponding longitudinal obstructed area according to the current infrared signal data to obtain coordinate information of the touch point, and returning the coordinate information of the touch point to the infrared touch bezel; and
reporting the coordinate information of the touch point to the system by the infrared touch bezel to achieve the touch-control function.

13. The all-in-one touch machine of claim 10, wherein comparing the current infrared signal data with a signal status of the each of the infrared receiving lamps in the signal data baseline library, the signal status in the signal data baseline library being in a state of no-touch, and obtaining an area with a change in received signals along a transverse direction and an area with a change in the received signals along a longitudinal direction according to the current infrared signal data in the infrared touch bezel, taking the area with a change in the received signals along the transverse direction as a transverse obstructed area, and taking the area with a change in the received signals along the longitudinal direction as a longitudinal obstructed area comprises:
comparing the current infrared signal data with the signal status of the each of the infrared receiving lamps in the signal data baseline library, the signal status in the signal data baseline library being in the state of no-touch, and obtaining the area with a change in received signals along the transverse direction and the area with a change in the received signals along the longitudinal direction according to the current infrared signal data in the infrared touch bezel; and
selecting the infrared receiving lamps with a signal value that is less than a threshold value respectively from areas with a change in the received signals along the transverse and the longitudinal directions, and taking intervals containing the infrared receiving lamps selected that are adjacent as the transverse obstructed area or the longitudinal obstructed area.

14. The all-in-one touch machine of claim 9, wherein reporting the coordinate information of the touch point to a system to achieve a touch-control function comprises:
transmitting the coordinate information of the touch point to a signal switch through USB, and further to a PC module or an external device through the signal switch, in order to realize the touch-control function.

15. An all-in-one touch machine, comprising an infrared touch bezel and a control mainboard, the infrared touch bezel including a first memory, a first processor, and a first computer program stored on the first memory and can run on the first processor, the control mainboard including a second memory, a second processor, and a second computer program stored on the second memory and can run on the second processor, the first processor executing the first computer program and the second processor executing the second computer program to implement the processing method for touch signals of claim 1 together.

16. The all-in-one touch machine of claim 15, wherein comparing the current infrared signal data with a pre-stored signal data baseline library and obtaining current touch-obstructed areas by the infrared touch bezel comprises:
comparing the current infrared signal data with a signal status of the each of the infrared receiving lamps in the signal data baseline library, the signal status in the signal data baseline library being in a state of no-touch, and obtaining an area with a change in received signals along a transverse direction and an area with a change in the received signals along a longitudinal direction according to the current infrared signal data in the infrared touch bezel, taking the area with a change in the received signals along the transverse direction as a transverse obstructed area, and taking the area with a change in the received signals along the longitudinal direction as a longitudinal obstructed area; and
taking all of the transverse obstructed area and the longitudinal obstructed area as the current touch-obstructed areas.

17. The all-in-one touch machine of claim 16, wherein determining whether the number of the touch-obstructed areas is greater than a predetermined value, uploading the current infrared signal data to the control mainboard if the number is greater than the predetermined value, or performing touch-control calculations on the current infrared signal data by the infrared touch bezel if the number is less than or equal to the predetermined value, obtaining coordinate information of a touch point, and reporting the coordinate information of the touch point to a system to achieve a touch-control function comprises:
comparing the number of the current touch-obstructed areas with the predetermined value in the infrared touch bezel and obtaining the comparison result;
uploading the current infrared signal data to the control mainboard if the number of the current touch-obstructed areas is greater than the predetermined value; and
calculating a center point of an overlapping area of each transverse obstructed area and the corresponding longitudinal obstructed area according to the current infrared signal data by the infrared touch bezel if the number is less than or equal to the predetermined value to obtain the coordinate information of the touch point, and reporting the coordinate information of the touch point to the system to realize the touch-control function.

18. The all-in-one touch machine of claim 16, wherein performing the touch-control calculations by the control mainboard according to the current infrared signal data received, obtaining the coordinate information of the touch point and returning the coordinate information to the infrared touch bezel, and reporting the coordinate information of the touch point to the system by the infrared touch bezel to achieve the touch-control function comprises:
receiving the current infrared signal data by the control mainboard, calculating a center point of an overlapping area of each transverse obstructed area and a corresponding longitudinal obstructed area according to the current infrared signal data to obtain coordinate information of the touch point, and returning the coordinate information of the touch point to the infrared touch bezel; and
reporting the coordinate information of the touch point to the system by the infrared touch bezel to achieve the touch-control function.

19. The all-in-one touch machine of claim 16, wherein comparing the current infrared signal data with a signal status of the each of the infrared receiving lamps in the signal data baseline library, the signal status in the signal data baseline library being in a state of no-touch, and obtaining an area with a change in received signals along a transverse direction and an area with a change in the received signals along a longitudinal direction according to the current infrared signal data in the infrared touch bezel, taking the area with a change in the received signals along the transverse direction as a transverse obstructed area, and taking the area with a change in the received signals along the longitudinal direction as a longitudinal obstructed area comprises:
comparing the current infrared signal data with the signal status of the each of the infrared receiving lamps in the signal data baseline library, the signal status in the signal data baseline library being in the state of no-touch, and obtaining the area with a change in received signals along the transverse direction and the area with a change in the received signals along the longitudinal direction according to the current infrared signal data in the infrared touch bezel; and
selecting the infrared receiving lamps with a signal value that is less than a threshold value respectively from areas with a change in the received signals along the transverse and the longitudinal directions, and taking intervals containing the infrared receiving lamps selected that are adjacent as the transverse obstructed area or the longitudinal obstructed area.

20. The all-in-one touch machine of claim 15, wherein reporting the coordinate information of the touch point to a system to achieve a touch-control function comprises:
transmitting the coordinate information of the touch point to a signal switch through USB, and further to a PC module or an external device through the signal switch, in order to realize the touch-control function.
